(19) United States
(12) Patent Application Publication
(10) Pub. No.: US 2005/0090018 A1
(43) Pub. Date: Apr. 28, 2005

(54) Method and detector capture of gases

(76) Inventors: Andreas Walte, Wohnsitz (DE); Wolf Munchmeyer, Wohnsitz (DE)

Correspondence Address: Horst M Kasper, 13 Forest Drive, Warren, NJ, 07059, US

(21) Appl. No.: 10/479,382

(22) PCT Filed: May 24, 2002
(86) PCT No.: PCT/DE02/01889

(30) Foreign Application Priority Data
May 25, 2001 (DE) 101 25 837.2

(51) Int. Cl. G01N 1/18

(52) U.S. Cl. 436/177; 422/83

(57) ABSTRACT

The aim of the invention is to improve the identification of individual gas compounds which co-exist with other compounds that have substantially higher concentrations. To achieve this, the adsorbent (2) is heated in a cyclic manner by a thermal shock treatment of the gas sensor (4) and the compounds that are released in cycles are diffused from the measured gas side through the membrane-type adsorbent (2) to the gas sensor (4) and are detected by the latter (4). The adsorbent (2) of the corresponding detector is configured as a flat or tubular membrane and is positioned directly adjacent to the gas sensor (4), without touching the latter. The adsorbent (2) separates the gas sensor (4) from the measured gas and is heated in a cyclic manner by the heater (6) of the gas sensor (4) in such a way that the desorbed gaseous compounds are identified using the active layer (5) of the gas sensor (4).

The Invention relates to a method according to the preamble of claim 1 and a corresponding detector according to the preamble of claim 4.

Such methods and detectors are employed for identifying of individual compounds in mixtures as well as also for identifying the mixtures. Applications can be found in environmental technology, safety technology such as for example for capturing of leakages in the industry or for example for smoldering fire recognition, in the foodstuffs industry, in the medical diagnostic, as well as also in the chemical industry for quality control purposes.

By now it has large importance that for example individual materials or the sum of individual compounds with certain properties such as for example the quality of the foodstuffs are correlated.

In part, these states can be captured with detectors, which detectors exhibit the shape of individual gas sensors or of a combination of various gas sensors.

The measurement signals of the individual gas sensors can then be compared with previously measured or, respectively, also with stored signals and the measured state can be described.

Such methods are a known for a longer time. Several of these systems are known since several years under the name “electronic nose”, wherein these systems are employed with several gas sensors with cross sensitivity in the form of gas sensor arrays. These apparatuses comprise an arrangement of a plurality of gas sensors, for example the “cold” gas sensors such as quartz oscillators or, respectively, conductive polymers or the “hot” gas sensors such as semiconductor gas sensors and out of a control electronic and an evaluation electronic or, respectively, an evaluation computer. The “cold” gas sensors are employed at ambient temperatures, whereas the “hot” gas sensors typically are employed at operating temperatures of the gas sensor between T=200 degrees centigrade and T=600 degrees centigrade.

It is furthermore known from the German printed Patent document DE-2313413A1 that the changing of the working temperature of the hot gas sensors is associated with the additional advantage that also the selectivity of the gas sensors is there with changed.

It is disadvantageous that in many applications the selectivity of the gas sensors are insufficient such that the gas sensors react for example to compounds or, respectively, to gases, which are present in high concentrations, but which are not relevant for the problem posed. This can be for example humidity or ozone in the ambient air, or methane in connection with capturing of smells in the environmental technology, up to ethanol in alcoholic beverages. An increase of the number of gas sensors does not always lead to an improvement of the separation.

It is disadvantageous that very frequently, such as for example in connection with the smells, the detection limit of the gas sensors is too small. A further disadvantage comprises that also sensor drift occurs with the simple gas sensors, which sensor drift operates negatively relative to the reproducibility and the compatibility between gas sensors of the same type.

Additional difficulties exist in connection with hot gas sensors upon application in the chemical industry, since frequently also the explosion protection has to be considered in the chemical industry.

It is known from W. Muenchmeyer et al. (2000), Sensors and Actuators B69,379-383 and the German Patent document DE-19807658 C1 that a selective enrichment is possible by employing of adsorbents, wherein the adsorbents are filled into small tubes as a granulate. The gas mixture is led for this purpose over an adsorbents granulate, such as for example special polymers (Tenax (R)) or carbon based adsorbents. The medium volatile and difficult to volatilize compounds are collected at the recited adsorbents by interactions with the adsorbents, whereas the easily volatile compounds are lead through the adsorbents. Usually the measurement gas is transported with a gas pump over the adsorbent. After a defined collection time the materials can be released again by way of heating or warming and can be detected with a detector or, respectively, a sensor arrangement. Smaller and easily volatile compounds can be enriched also over other adsorbents such as for example zeolites, active carbon or silicates.

It is disadvantageous that in the latter case difficult to volatilize materials are also enriched, but these materials are not released by way of thermal desorption and they change the properties of the adsorbent.

It is known from the European Patent document EP 00055624 A1 that the adsorbents can also be produced in the shape of a membrane. The membrane is heated after the enrichment phase and released compounds are detected in a following detector, which is in this case a mass spectrometer.

It is a disadvantage in connection with this method that enrichment and gas sensors are physically separated and usually to apparatuses are constructed such that for example complex gas paths with in part several pumps and extensive electronics are necessary, wherein the extensive electronics has to be supplied with a correspondingly high electric power. It is in addition disadvantageous that the adsorbent becomes soiled in case of high dust load and thus the properties of the adsorbent are there with changed.

It is known from the U.S. Pat. No. 5,783,154 that hot metal oxide sensors are also coated with thin silicon layers, in order to influence the selectivity of the sensor through diffusion effects.

It is disadvantageous that no enrichment is possible based on the direct contact with the sensor and that the selectivity is controlled primarily through the geometry of the molecules. Polymers cannot be employed here because of the high-temperature of the sensors.

It is further known from JP 58124939 A and Motorola “MGS 1100 carbon monoxide gas sensor”, Motorola semiconductor technical data, MGS1100/D (1997) that the selectivity can be influenced by coupling of a hot sensor with porous layers out of silica gel, zeolites, and calcium chloride, and bore, respectively in the case of Motorola an active carbon filter. For example in case of Motorola the cross sensitivity of a carbon monoxide sensor was decreased relative to volatile organic compounds. It is disadvantageous that the sensor is not cleaned and the porous particle, or, respectively, the active carbon filter do not any longer filter after a certain time and the materials not of interest pass to the sensor, which materials trigger erroneous measurements. High concentrations of solvents, of cigarette smoke, or of ammonia are therefore to be avoided according to the data sheet of Motorola.

It is known in connection with the quartz oscillator sensors (cold gas sensor) that they are different interactions of the materials to be measured with the polymer, wherein the polymer is applied on the quartz oscillator as an adsorbent.

The long kinds which are required for desorption or, respectively, cleaning of the sensitive layers (polymers) are disadvantageous in case not easily volatilized compounds condense on the layers.

It is known from P. Boecker et al. (2000), sensors and actuators B 70,37-42 that the desorption of the materials can be accelerated by an alternating temperature operation of the cold sensors and the therewith also the measurement cycles can be shortened. It is disadvantageous that then also the sensor becomes warm and heated based on the direct contact with the sensor. Since the measurement signal to a much depends on temperature with this type of sensor, the second sensor becomes necessary in order to take into consideration the change of the temperature. Therefore there is the object of developing the method and an apparatus which improves the detection limit of the detectors and simultaneously increases the selectivity, that is the detection of individual compounds with simultaneous presence of other compounds in substantially higher concentrations. In addition to the necessity exists to improve the drift of the sensor and the there with also the lifetime of the gas sensors based on a protection against dust and aerosols.

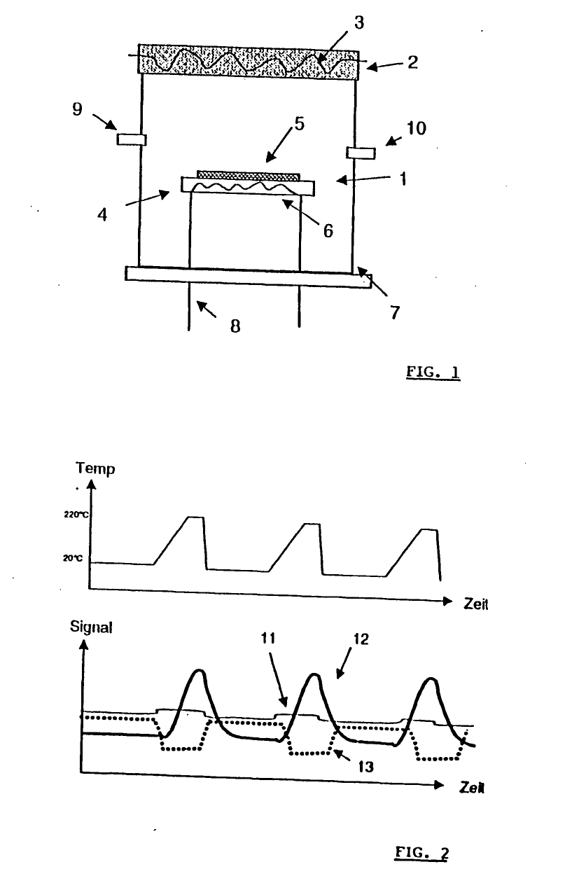

The Invention is to be explained in more detail by way of a schematic representation with a metal oxide sensors in FIG. 1. There is shown:

FIG. 1: detector with flat membrane.

FIG. 2: measurement signals of the detector corrected relative to temperature effects.

The arrangement for performing the method for the determination of gaseous compounds comprises mainly a detector 1, wherein the detector 1 comprises a combination of an adsorbent 2,which adsorbent 2 is furnished optionally with the possibility for thermo heating, that is a heating element 3, and a gas sensor 4. The gas sensor for is furnished with electrical feed lines for reading out the measurement signal from the gas sensitive layer 5 and also serving for energy supply of the gas sensor. Furthermore the carrier substrate is shown with a heater 6 for the gas sensor and the casing of the detector 7. The necessary electrical connections 8 and an optional in that for flushing gas 9 or, respectively outlet 10 are illustrated in addition.

The adsorbent is advantageously formed in the shape of a membrane, wherein the membrane envelopes the gas sensor 4 without touching the gas sensor 4. Polymers such as for example silicones, fluoro-elastomerics, or Tenax membranes are employed as membrane materials, wherein the polymers can enrich medium volatile compounds and not easily volatilized compounds in a cold state. The enriched compounds can be released again through a thermal desorption, that is a warming of the membrane. The selectivity of the gas sensor is increased by an operation with changing temperature, that is the cold membrane serves for enriching and in the following the warm membrane serves for releasing the compounds. The desorbed compounds have to pass or a solution diffusion process from the measurement gas side through the adsorbent in the form of a membrane to the detector.

The detection limit is improved with the membrane and the membrane serves simultaneously however also for protecting the detector, since interfering particles or substances forming particles cannot pass onto the detector. In addition the explosion protection properties of some detectors, in particular the hot sensors, can be improved.

The disadvantageous to employ also membranes which are filled with other absorbents such as for example Tenax (R), carbon based adsorbents, zeolites, Calixarene and so on in order to change the selectivity of the adsorbents in the shape of membranes. Also the lifetime of the adsorbent is improved than employing elastomers such as silicon or Viton as a membrane material, since no particles can pass into the pores of the granulate of the adsorbent through the smooth membrane and they also cannot obstruct and plug the pores. It is in addition prevented, that not easily volatile compounds with a small diffusion rates pass through the membrane onto the adsorbent, wherein the not easily volatile compounds cannot be thermally use all with the employed filling materials (adsorbents).

The direct heating of the adsorbents is not always necessary upon employment of hot gas sensors such as for example MOS, MOSFET or Pellistores, since the gas sensors are warmed by heat transport such as convection or diffusion simultaneously through an alternating temperature operation of the gas sensor.

This is in particular with the above recited gas sensors associated with the advantage that in case of a cold membrane such as for example are silicon membrane with Tenax filling, only small molecules such as for example H2, CO, CH4 are measured while at larger temperatures also medium volatile and not easily volatile compounds are captured.

The measurement signals of a detector at alternating temperature operation is illustrated by way of example in FIG. 2. The measurement signal corrected of clean temperature effects of an MOS gas sensor is illustrated as a function of time in connection with a cyclically heated membrane. The measurement signal of a mixture of easily volatile and not easily volatile compounds with or without addition of reference air is illustrated during the thermal desorption. Only easily volatile compounds are measured by the membrane is cold. If only easily volatile compounds are present, then the increase of temperature of the membrane exerts only a small influence on the measurement signal. The detector signal in case of easily volatile compounds 11 is characterized by a not very pronounced temperature dependence of the measurement signal of the detector.

The detector signal in the presence of medium volatile to not easily volatile compounds 12 clearly shows signal rises during the heating, since these compounds are now released and better pass through the membrane. In case medium volatile and not easily volatile compounds are not to be captured, then the space between membrane and sensor can be flushed with clean air during the warming of the membrane. The curve of the detector signal for easily volatile compounds with flushing with zero air during the desorption 13 is clearly distinguished from the results without flushing, since the enriched compounds pass only in thinned form to the gas sensor, if at all.

The detection limits for some compounds can be substantially improved based on the selection of the filling material of the membrane. For example zeolites or “Nano tubelets” out of carbon can be employed in order to in rich selectively also small molecules, or, respectively permanent gases up to hydrogen. Based on the described construction also the production costs can be decreased substantially besides the increase of the detection limit and the improvement of the selectivity.

In particular the protective effect of the membrane with respect to contamination with particles, liquids or also the influence of air streams carry the situation here. The detector can also be employed in very dusty environments based on the protective effect, such as for example for gas measurement in exhaust gases or as a fire alarm. Analysis of liquids, for example solvents in Walter, can be performed also with the detector, in particular if the liquid is removed during the phase of the heating out of the membrane. It is furthermore advantageous through a combination of these gas sensors and of the membrane, for example different membranes at one gas sensor or at one membrane with an arrangement of gas sensors to realize measurement systems for different applications. The detectors can be integrated into a sensor chamber with a sample taking system or can also be directly employed in the process.

1. Method for determination of gaseous compounds in air loaded with dust with a detector (1), wherein gaseous compounds are physically separated by a membrane shaped adsorbent (2) from a gas sensor, wherein the gaseous compounds in a cold state high enriched on the adsorbent (2) and are again released in a hot state by a warming of a gas sensor, characterized in that the adsorbent is cyclically heated by an alternating temperature operation of the gas sensor and the cyclically released compounds diffuse from the measurement gas side through the membrane shaped adsorbent to the gas sensor (4) in order to again capture the released compounds with the gas sensor.

2. Method according to claim 1 characterized in that the adsorbent (2) is flushed with clean air or, respectively, a defined reference air during the desorption from the measurement gas side or also from the side of the gas sensor for capturing therewith only the previously adsorbed chemical compounds by way of the diffusion through the adsorbent to the gas sensor.

3. Method according to claim 1 characterized in that the detector (1) is employed for the analysis of liquids by having the liquid flow on one side over the adsorbent (2), wherein the liquid as required is removed and in the following the adsorbent (2) is heated and the compounds derived from the liquid diffuse through the warm membrane shaped adsorbent (2) to the sensor.

4. The detector (1) for performing the method characterized in that the adsorbent (2) is disposed immediately at the gas sensor (4) in the form of a flat membrane or of a hose membrane without touching the gas sensor (4) and thereby separating the gas sensor from the measurement gas and wherein the membrane is cyclically heated by the heater of the gas sensor (6) through the hot sensor by way of convection, diffusion or thermal radiation such that the desorbed gaseous compounds can be detect it with the effective layer of the gas sensor (5).

5. Detector (1) according to claim 4 characterized in that openings (9), (10) are furnished at the casing of the detector (7) for flushing of the intermediate space.

6. Detector according to claim 4 characterized in that the adsorbent (2) is cyclically heated through the additional heating element (3).

7. Detector according to claim 4 characterized in that the adsorbent (2) comprises an organic adsorbent material such as Tenax or an elastomeric such as for example silicon or Viton for determining medium volatile and not easily volatile compounds.

8. Detector according to claim 4 characterized in that the adsorbent (2) is modified with certain filling materials, which are capable of selectively adsorbing and desorbing materials, such as for example Tenax or, respectively, Calixarene or carbon based adsorbents such as for example Carbotrap, Carbosieve or for easily volatile compounds with the zeolites, silica gel or nano tubelets.

9. Detector according to claim 4 characterized in that the adsorbent (2) comprises a plastic material for the determination of easily volatile compounds, and wherein the plastic material is characterized by a small sword utility for organic compounds such as for example Kapton or Teflon.

10. Detector according to claim 4 characterized in that an arrangement of several gas sensors (4) is positioned behind an adsorbent (2).

11. Detector according to claim 4 characterized in that an arrangement of several adsorbents (2) is positioned in front of a gas sensor (4).

12. Detector according to claim 4 characterized in that several detectors (1) are employed, wherein it the detectors in each case are equipped with an adsorbent (2) or different adsorbents.

13. Detector according to claim 11 characterized in that the adsorbent (2) are heated out at different times and therewith allow a continuous monitoring.

14. Detector according to claim 12 characterized in that several detectors (1) are employed and are heated out at different times in order to the allow therewith a continuous monitoring.
